(19) United States
(12) Patent Application Publication
(10) Pub. No.: US 2025/0353327 A1
(43) Pub. Date: Nov. 20, 2025

(54) CANTILEVER BEARING ARRANGEMENT FOR CVJ FRONT STEER AXLE

(71) Applicant: Dana Automotive Systems Group, LLC, Maumee, OH (US)

(72) Inventor: Corey KWAPICH, Ottawa Lake, MI (US)

(21) Appl. No.: 19/207,135

(22) Filed: May 13, 2025

Related U.S. Application Data
(60) Provisional application No. 63/647,779, filed on May 15, 2024.

(51) Int. Cl. B60B 35/12; B60B 35/00; B60B 35/16; B62D 7/18

(52) U.S. Cl. CPC B60B 35/128; B60B 35/003; B60B 35/16; B62D 7/18

(57) ABSTRACT

Systems for an axle assembly are provided. In one example, a system includes a first shaft extending through an axle housing, a constant velocity joint (CVJ) coupled to the first shaft at a location outside of the axle housing, a bearing assembly arranged at an end of the axle housing proximal to the CVJ, and a second shaft extending through a wheel hub assembly and coupled to the CVJ, wherein an outer race of the CVJ is in face-sharing contact with a wheel hub of the wheel hub assembly.

### CROSS REFERENCE TO RELATED APPLICATIONS

The present application claims priority to U.S. Provisional Application No. 63/647,779, entitled “CANTILEVER BEARING ARRANGEMENT FOR CVJ FRONT STEER AXLE”, and filed on May 15, 2024. The entire contents of the above-listed application are hereby incorporated by reference for all purposes.

### TECHNICAL FIELD

The present description relates to a constant velocity joint (CVJ) assembly for a steer axle.

### BACKGROUND AND SUMMARY

Vehicles may have a plurality of configurations of axle assemblies that include an input rotational element that rotatably couples to a wheel. For example, the input rotational element may include a steer axle. The steer axle may have an axle shaft that rotatably couples to the wheel of the vehicle. The axle shaft may be rotatably coupled to wheels via joints, such as via one or more constant velocity joints (CVJs). For example, the CVJ may rotatably couple the axle shaft to a shaft that rigidly couples the wheel hub. The CVJ may include an outer race rigidly coupled to the shaft rigidly coupled to the hub adapter, and the CVJ may include an inner race rigidly coupled to the axle shaft. The shaft may rigidly couple to the wheel hub of the wheel assembly via a plurality of external splines. The plurality of external splines may mate with the hub adaptor of the wheel hub. The CVJ assembly may include a spindle, where the spindle may support the wheel hub and rigidly couple to an axle housing of the steer axle. In this way, the wheel hub may ride on and be positioned around the spindle.

A CVJ assembly may present certain challenges when supporting the wheel hub via the spindle. For example, the CVJ may be physically large relative to the packing space of the spindle. Such a CVJ may be too large to fit to the spindle and the wheel bearing. There may also be a desire for a spindle and wheel bearing to be a volume to fit to a packaging space below a first threshold, particularly for a front steering axle. There may also be a desire for the CVJ assembly to be below a threshold of weight.

The inventors herein have recognized these and other issues with such systems and have developed approaches to at least partially solve them. In one example, a system includes a first shaft extending through an axle housing, a constant velocity joint (CVJ) coupled to the first shaft at a location outside of the axle housing, a bearing assembly arranged at an end of the axle housing proximal to the CVJ, and a second shaft extending through a wheel hub assembly and coupled to the CVJ, wherein an outer race of the CVJ is in face-sharing contact with a wheel hub of the wheel hub assembly.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example schematic of a vehicle with a front steer axle including one or more of the constant velocity joints (CVJs) and wheel assemblies of the present disclosure.

FIG. 2 shows a sectional view of an assembly including a CVJ and a hub assembly of the present disclosure.

### DETAILED DESCRIPTION

The following description relates to a system for supporting a constant velocity joint (CVJ) of a joint assembly and a wheel assembly for an axle assembly. The axle assembly includes an axle housing and a steer axle. The joint assembly includes the CVJ and a steering knuckle.

The CVJ may rotatably couple to a wheel hub of the wheel assembly. The steer axle may be a front side steer axle, with an axle shaft that that rotatably couples to the CVJ. The wheel hub assembly may include a stub shaft and the wheel hub, where the stub shaft inserts through the wheel hub. The axle shaft may rotationally couple to an inner race of the CVJ, and the stub shaft may rotationally couple to a spindle of the CVJ.

The axle shaft may be at least partially supported by a bearing assembly. The bearing assembly is retained within walls of a tube the axle housing that is concentric with the axle shaft. In this way, the CVJ may be cantilevered from a wheel end of the bearing assembly via the axle shaft. The bearing assembly may be the only bearings supporting the axle shaft prior to its exit from the tube of the axle housing toward the CVJ. In this way, a cantilevered portion of the axle shaft is coupled to and supports the CVJ.

During disassembly of the wheel assembly, such as when service is executed, the wheel hub (e.g., a spindle) may be removed from the hub assembly, such that the CVJ remains in place and is supported via the axle shaft. In one example, the wheel assembly may not include an adapter.

The stub shaft has an input side and an output side, where the input side may receive torque from a component and the output side may deliver torque to another component. The input side may couple to the CVJ. The output side may couple to the hub assembly. The stub shaft includes a splined end at a first extreme end and an end plate at a second extreme end opposite the first extreme end.

In another example, an assembly includes an axle housing, a first shaft, a first bearing assembly, the CVJ, wherein the CVJ including an outer race and an inner race, where the outer race is around the inner race, a second shaft; a wheel hub; and a wheel assembly. Optionally, the axle housing may house the first shaft. Optionally, and/or in addition, the CVJ may be interposed between the axle shaft and the wheel hub. Optionally, and/or in addition, the wheel hub may be positioned between the CVJ and the wheel assembly. Optionally, and/or in addition, the first bearing assembly may be retained between the axle housing and the axle shaft. Optionally, and/or in addition, the first bearing assembly may be arranged radially around the first shaft. Optionally, and/or in addition, the first shaft may be supported by the first bearing assembly. Optionally, and/or in addition, the first shaft may be in meshed engagement with the inner race. Optionally, and/or in addition, the second shaft may be in meshed engagement with a spindle of the CVJ. Optionally, and/or in addition, the CVJ may be surrounded by the spindle. Optionally, and/or in addition, the assembly may lack a bearing that contacts both the outer race and the spindle.

Arranging a bearing around the axle shaft of the CVJ, and/or enclosing and retaining the bearing to a tube of the axle housing, allows for support of the CVJ. The outer race of the CVJ may be unsupported and not having a bearing. More specifically there may not be a bearing between the outer race and spindle/wheel hub to support the outer race. Additionally, the number of interfaces that add tolerance between the CVJ and a king pin axis of a steering knuckle are reduced. Reducing the interfaces may help maintain alignment of the CVJ relative to the king pin and king pin axis of the steering knuckle. This design also may present advantages for service, as the CVJ may be left in place when removing the spindle.

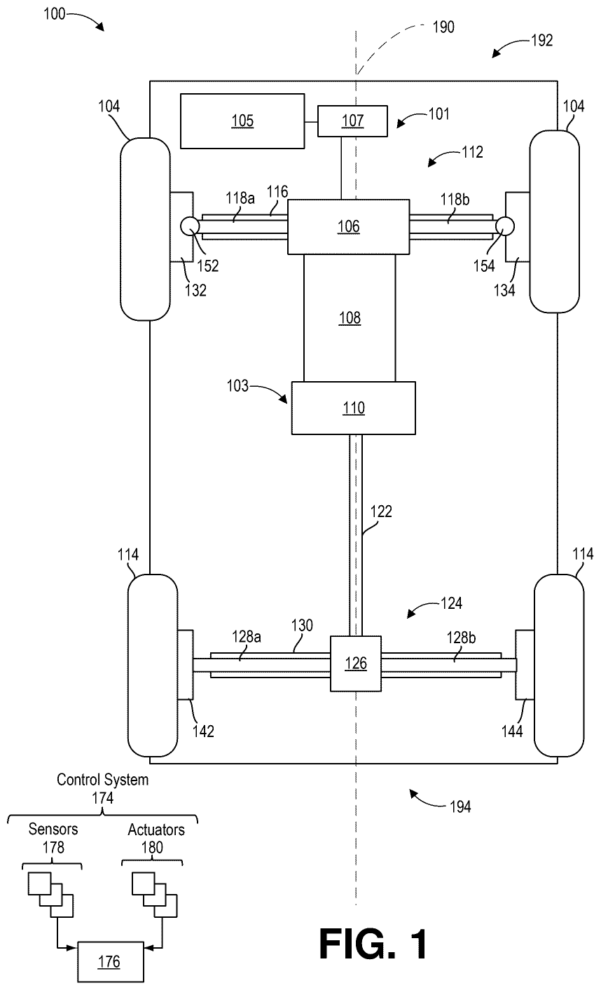

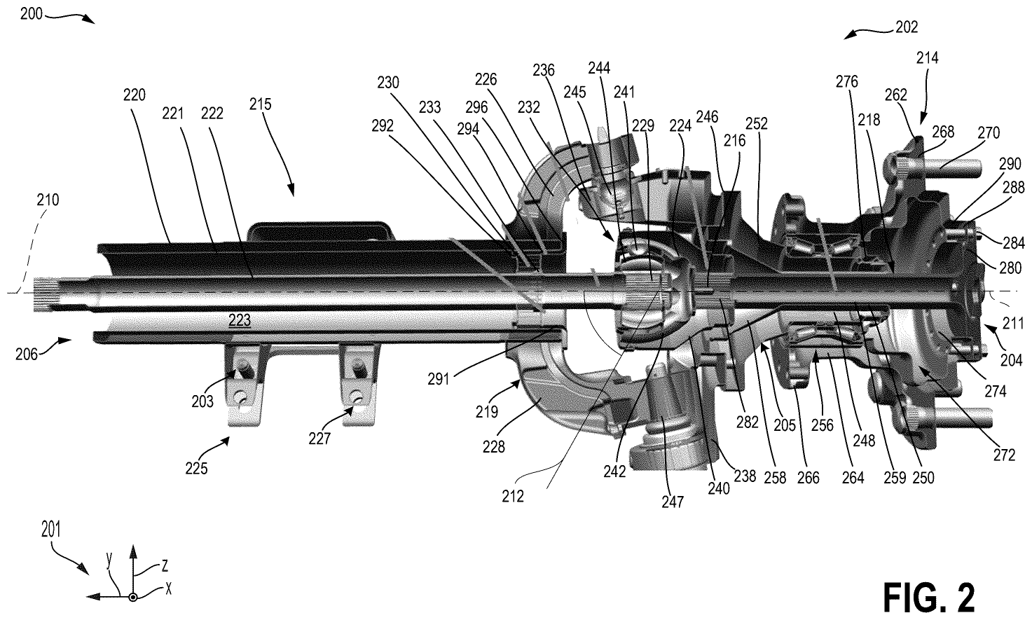

FIG. 1 shows an example schematic of a vehicle which includes one or more constant velocity joints (CVJs) and wheel end assemblies of the present disclosure. FIG. 2 shows an exploded view of an assembly including a CVJ and a wheel hub of the present disclosure.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

FIG. 1 shows a schematic of an example configuration with relative positioning of the various components. FIG. 2 shows an example configuration with approximate position. FIG. 2 is shown approximately to scale; though other relative dimensions may be used. As used herein, the terms “approximately” is construed to mean plus or minus five percent of the range unless otherwise specified.

Further, FIGS. 1-2 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis and a vertical axis. Features described as lateral may be approximately parallel with the lateral axis. A vertical axis may be normal to a lateral axis and a longitudinal axis. Features described as vertical may be approximately parallel with a vertical axis with respect to gravity.

Features described as drivingly coupled are coupled such as to drive one another. Said in another way, a first component drivingly coupled to a second component may drive the second component and vice versa. Features described as rotatably coupled are coupled such as to rotate with one another. Said in another way, a first component rotatably coupled to a second component such as rotate as the second component rotates and vice versa.

Turning now to FIG. 1, a vehicle 100 is shown including a powertrain 101 and a drivetrain 103. The vehicle 100 may have a front end 192 and a rear end 194, located on opposite sides of vehicle 100. Objects, components, and features of the vehicle 100 referred to as being located near the front may be closer to the front end 192 compared to the rear end 194. Objects, components, and features of the vehicle 100 referred to as being located near the rear may be closest to the rear end 194 compared to the front end 192. The vehicle 100 may have a longitudinal axis 190 parallel to a direction of vehicle 100 travel.

The powertrain 101 may include a prime mover 106 and a transmission 108. For an example, the prime mover 106 may be an internal combustion engine (ICE). For another example, the prime mover 106 may be an electric machine. The prime mover 106 is operated to provide rotary power to the transmission 108. The transmission 108 receives the rotary power produced by the prime mover 106 as an input and outputs rotary power to the drivetrain 103 in accordance with a selected gear or setting.

The vehicle 100 may be a commercial vehicle, light, medium, or heavy duty vehicle, a passenger vehicle, an off-highway vehicle, a commercial vehicle, agricultural vehicle, and/or sport utility vehicle. For an example embodiment, the vehicle 100 may be a wheeled vehicle, such as an automobile. However, additionally or alternatively, the vehicle 100 may be plane, a boat, or other vehicle system. Additionally or alternatively, the vehicle 100 and/or one or more of its components, such as components of the powertrain 101 and/or the drivetrain 103, may be used in industrial, locomotive, military, agricultural, and/or aerospace applications. In an example, the vehicle 100 is an all-electric vehicle or a vehicle with all-electric modes of operation, such as a plug-in hybrid vehicle. As such, the prime mover 106 may be an electric machine, such as an electric motor/generator. For an example, the vehicle 100 may be a hybrid vehicle, wherein there are multiple torque inputs to the transmission 108. As such there may be at least another mover with an input to the transmission 108 besides prime mover 106. If the prime mover 106 is an ICE or another non-electric machine mover, the other mover may be an electric machine, such as an electric motor or an electric motor/generator.

The prime mover 106 may be powered via energy from an energy storage device 105. For example, the energy storage device 105 is a battery, such as a traction battery, configured to store electrical energy. An inverter 107 may be arranged between the energy storage device 105 and the prime mover 106 and configured to adjust direct current (DC) to alternating current (AC). The inverter 107 may include a variety of components and circuitry with thermal demands that effect an efficiency of the inverter.

The drivetrain 103 may include a first axle assembly 112 and a second axle assembly 124. The first axle assembly 112 may be or include a steer axle. The second axle assembly 124 may be or include a drive axle. The first axle assembly 112 may be configured to support and steer a first set of wheels 104. The first and second axle assemblies 112, 124 may each be supported by a suspension system. Additionally or alternatively, the first and second axle assembly 112, 124 may be directly mounted to a vehicle body, such as a vehicle underbody which faces a ground on which a vehicle moves. The second axle assembly 124 may be configured to rotate a second set of wheels 114. For example, the first axle assembly 112 may be arranged near the front of the vehicle 100 and thus may be interchangeably referred to as a front axle. The second axle assembly 124 may be arranged near the rear of the vehicle 100 and thus may be referred to as a rear axle. However, it should be appreciated, that the arrangement of the first axle assembly 112 and the second axle assembly 124 may be non-limiting. For another example, the second axle assembly 124 may be arranged near the front of the vehicle 100 and thereby comprise a front axle. Likewise, the first axle assembly 112 may be arranged near the rear of the vehicle and thereby comprise a rear axle. The vehicle 100 may include additional wheels that are not coupled to the drivetrain 103.

The vehicle 100 may have a driveshaft 122. The transmission 108 may be mechanically coupled the second axle assembly 124 via the driveshaft 122. Said in another way, the transmission 108 may drivingly couple to the driveshaft 122, and the driveshaft 122 may drivingly couple the second axle assembly 124. In some configurations, such as shown in FIG. 1, the drivetrain 103 includes a transfer case 110 configured to receive rotary power output by the transmission 108. The driveshaft 122 may drivingly couple to the transfer case 110 and may be drivingly coupled to the transmission 108 via the transfer case 110.

The first axle assembly 112 may include a first axle housing 116 and a first set of axle shafts. The first axle housing 116 may house the first set of axle shafts. For example, the first set of axle shafts may include a first shaft 118a and a second shaft 118b that may each be housed by the first axle housing 116. The first shaft 118a and the second shaft 118b may be axle half shafts.

The second axle assembly 124 may include a differential 126, a second axle housing 130, and a second set of axle shafts. The differential 126 may drivingly couple and rotatably couple the second set of axle shafts such as to transfer torque to and drive the second set of axle shafts. Likewise, the second axle housing 130 may house the second set of axle shafts. The second set of axle shafts may include a third shaft 128a and a fourth shaft 128b. The third shaft 128a and the fourth shaft 128b may be axle half shafts. The third and fourth shafts 128a, 128b may be housed by the second axle housing 130. The third and fourth shafts 128a, 128b may each rotatably couple the differential 126. The differential 126 may distribute various values of torque to wheels drivingly coupled at opposite ends of the second axle assembly 124. For example, the differential 126 may distribute unequal torque to the third shaft 128a and the fourth shaft 128b.

The first and second shafts 118a, 118b may drivingly couple to the set of wheels 104 via a set of wheel end assemblies and a plurality of joints. For example, the first set of wheel end assemblies may include a first wheel end assembly 132 and a second wheel end assembly 134. The first wheel end assembly 132 may rotatably couple to one or more wheels of the first set of wheels 104. Likewise, the second wheel end assembly 134 may rotatably couple to one or more wheels of the first set of wheels 104. Wheels drivingly coupled to the first wheel end assembly 132 may be arranged on an opposite end of the first axle assembly 112 relative to wheels drivingly coupled to the second wheel end assembly 134. The first wheel end assembly 132 has a first joint 152, and the second wheel end assembly 134 has a second joint 154. The first shaft 118a may rotatably couple to the first wheel end assembly 132 via the first joint 152. Said in another way, the first shaft 118a may rotate with the first wheel end assembly 132 and with one or more wheels of the wheels 104 and vice versa. The second shaft 118b may rotatably couple to the second wheel end assembly 134 via the second joint 154. Said in another way, the second shaft 118b rotate with the second wheel end assembly 134 and with one or more wheels of the wheels 114, and vice versa.

The third and fourth shafts 128a, 128b may drivingly couple to the second set of wheels 114 via a set of wheel end assemblies and a plurality of joints. For example, the first set of wheel end assemblies may include a third wheel end assembly 142 and a fourth wheel end assembly 144. The third wheel end assembly 142 may drivingly couple to one or more wheels of the set of wheels 114. Likewise, the fourth wheel end assembly 144 may drivingly couple to one or more wheels of the set of wheels 114. Wheels drivingly coupled to the third wheel end assembly 142 may be opposite the second axle assembly 124 from the wheels drivingly coupled to the fourth wheel end assembly 144. The third wheel end assembly 142 has a first joint 152, and the fourth wheel end assembly 144 has a second joint 154. The third shaft 128a may drivingly couple and rotatably couple to the third wheel end assembly 142 via the first joint 152. The fourth shaft 128b may drivingly couple and rotatably couple to the fourth wheel end assembly 144 via the second joint 154. Torque output by the differential 126 to the third shaft 128a may drive the third wheel end assembly 142 and one or more wheels of the wheels 114. Torque output by the differential 126 to the fourth shaft 128b may drive the fourth wheel end assembly 144 and one or more wheels of the wheels 114.

The vehicle 100 and drivetrain 103 may include a plurality of CVJs. A CVJ may drivingly couple at least a first rotational element and a second rotational element, such as separate shafts arranged in series, such that a first rotational element and a second rotational may rotate or pivot freely, and the first rotational element may drive the second rotational element, and vice versa, at an angle between the first rotational element and the second rotational element. The CVJ may compensate for the angle between the first rotational element and the second rotational element may be between a range of threshold of angles. The angle between the first rotational element and the second rotational element may change during rotation, such as during operations of the suspension, where a position of the first axle or the second axle may change. The first joint 152 and the second joint 154 may be CVJs. Additionally, other CVJs may drivingly couple to other shafts and rotational elements of vehicle 100.

Adjustment of the drivetrain 103 between the various modes of operation as well as control of operations within each mode may be executed based on a vehicle control system 174, including a controller 176. Controller 176 may be a microcomputer, including elements such as a microprocessor unit, input/output ports, an electronic storage medium for executable programs and calibration values, e.g., a read-only memory chip, random access memory, keep alive memory, and a data bus. The storage medium can be programmed with computer readable data representing instructions executable by a processor for performing the methods described below as well as other variants that are anticipated but not specifically listed. In one example, controller 176 may be a powertrain control module (PCM).

Controller 176 may receive various signals from sensors 178 coupled to various regions of vehicle 100. For example, the sensors 178 may include sensors at the prime mover 106 or another mover to measure mover speed and mover temperature, a pedal position sensor to detect a depression of an operator-actuated pedal, such as an accelerator pedal or a brake pedal, a lever position sensor to detect a shifting of a lever, such as a brake lever, speed sensors at the first set of wheels 104 and the second set of wheels 114, etc. Upon receiving the signals from the various sensors 178 of FIG. 1, controller 176 processes the received signals, and employs various actuators 180 of vehicle 100 to adjust drivetrain operations based on the received signals and instructions stored on the memory of controller 176. For example, controller 176 may receive an indication of depression of the brake pedal, signaling a desire for decreased vehicle speed. Vehicle braking may be directly proportional to accelerator pedal position, for example, degree of depression. For another example, controller 176 may receive an indication of depression of the accelerator pedal, signaling a desire for increased vehicle speed. Vehicle acceleration may be directly proportional to accelerator pedal position, for example, degree of depression. In response, the controller 176 may command operations, such as shifting gear modes of the transmission 108. Alternatively, the gear modes of the transmission 108 may be shifted manually, such as if the transmission 108 is a manual transmission.

The transmission 108 may be a gearbox. Alternatively, the transmission 108 may be an axle transmission or a trans axle transmission, and may be arranged or be part of a drive axle assembly, such as the second axle assembly 124. In some embodiments, additionally or alternatively, the transmission 108 may be a first transmission, and the vehicle 100 may have a second transmission. The second transmission may be arranged nearer to the rear side or in another position of the vehicle 100 compared to transmission 108.

The drivetrain 103 is shown in a rear-wheel drive configuration, although other configurations are possible. For one or more examples, the drivetrain 103 may include a front-wheel drive, a four-wheel drive configuration, or an all-wheel drive configuration. Further, the drivetrain 103 may include one or more tandem axle assemblies. For example, there may be one or more axle assemblies in addition to the first axle assembly 112 and the second axle assembly 124, therein there may be one or more axles in addition to the axles of the first and second axle assemblies 112, 124. The one or more of the additional axle assemblies may be drivingly coupled to the transmission such as to be driven by the transmission 108 or another transmission. As such, the drivetrain 103 may have other configurations without departing from the scope of this disclosure, and the configuration shown in FIG. 1 is provided for illustration, not limitation. For example, in some embodiments, additionally or alternatively, the transmission 108 may be a first transmission, and the vehicle 100 may have a second transmission arranged on the second set of axle shafts. The transmission 108 may be a gearbox. Alternatively, the transmission 108 may be an axle transmission or a trans axle transmission.

A set of reference axes 201 are provided for the view shown in FIG. 2. The reference axes 201 indicate a y-axis, an x-axis, and a z-axis. In one example, the z-axis may be parallel with a direction of gravity, and the x-y plane may be parallel with a horizontal plane that an assembly 202 of FIG. 2 may rest upon. A circle may represent an axis of the reference axes 201 that is normal to a view. A filled circle may represent an arrow and axis facing toward, or positive to, a view. Axles of the FIG. 2 may be parallel to the y-axis.

Turning to FIG. 2, a view 200 of the assembly 202 is shown. In one example, the assembly 202 is a section of a drivetrain assembly. The components of the assembly 202 may be centered around a first axis 210 and a second axis 211. Some components or features may be arranged radially around the first axis 210 and/or the second axis 211. The first and second axes 210, 211 therein may be central axes of the assembly 202. The first and second axes 210, 211 may also be rotational axes along which rotating elements of the assembly 202 rotate or spin about. The first axis 210 and the second axis 211 may be co-axial. However, the first axis 210 may extend at an angle 212 from the second axis 211, and vice versa, during certain operations of a vehicle (e.g., vehicle 100 of FIG. 1) including the assembly 202. The assembly 202 includes a wheel end assembly. The wheel end assembly included by assembly 202 may be an example configuration of the first wheel end assembly 132 or the second wheel end assembly 134 of FIG. 1. As such, components illustrated in the figure may be mirrored on an opposite end of the assembly 202 for a different wheel end assembly.

The assembly 202 may have a first side 204 and a second side 206, where the first side 204 is opposite the second side 206. The first side 204 may be a wheel side that may be positioned nearest to a wheel of the vehicle, such as a wheel of the wheels 104 of vehicle 100 of FIG. 1. The second side 206 may be an axle side that may be positioned closest to the axle of a vehicle, such as the axle of the first axle assembly 112 of FIG. 1.

The assembly 202 may comprise a plurality of sub-assemblies, including a joint assembly, a wheel assembly 214, and a portion of an axle assembly 215. The wheel assembly 214 is nearest to the first side 204. The wheel assembly 214 may rigidly couple to at least one wheel. The axle assembly 215 may be closer to the second side 206 of the assembly 202. The joint assembly may be sandwiched between and coupled to the wheel assembly 214 and the axle assembly 215. The joint assembly may include a constant velocity joint (CVJ) 232, a wheel hub 205, a steering knuckle 224, and a first bearing assembly 230. The wheel hub 205 may be interchangeably referred to as an outer spindle. The steering knuckle 224 may couple to the spindle 216. A stub shaft 218 may include a splined end 282 coupled to the spindle 216. More specifically, the stub shaft 218 may rotatably couple the CVJ 232 to the wheel assembly 214. The wheel assembly 214 may rotatably couple to a wheel, such as to drive or rotate the wheel. In one example, the wheel assembly 214 lacks a hub adaptor. The stub shaft 218 may therein rotatably couple to the wheel assembly 214 without coupling to a hub adapter.

The axle assembly 215 may be a configuration of the first axle assembly 112 of FIG. 1. The CVJ 232 may be a configuration of the CVJ used for the first joint 152 and the second joint 154 of FIG. 1. In this way, only one CVJ is associated with each wheel end of the front axle

The axle assembly 215 may include an axle housing 220 and a first axle 222. The first axle 222 is interchangeably referred to herein as an axle shaft 222 and/or bar shaft 222. The axle shaft 222 may be housed in a passage 221 of a tube 223 of the axle housing 220. The axle housing 220, the passage 221, and the axle shaft 222 may be centered around the first axis 210. The tube 223 may include an inner surface. The inner surface may shape the passage 221 and face the axle shaft 222. For example, the tube 223 may be cylindrical and curve radially about the passage 221. The axle shaft 222 may rotatably couple to the CVJ 232, such as to drive or rotate the spindle 216 of the CVJ 232. The axle shaft 222 may be an example configuration of the first shaft 118a or the second shaft 118b of FIG. 1.

The axle housing 220 may further include a mounting bracket 225. The mounting bracket 225 may include a plurality of through holes 227 for receiving one or more fasteners and a plurality of fasteners 203 for coupling the axle housing 220 to a portion of the vehicle. In one example, the mounting bracket 225 may couple to a vehicle suspension system and/or to a vehicle underbody frame. The plurality of through holes 227 may include two through-holes, each configured to receive one fastener.

The axle housing 220 may include a steering knuckle 219 including a first appendage 226 and a second appendage 228. The first appendage 226 and the second appendage 228 may be coupled to a second yoke including a first arm 236 and a second arm 238. The first appendage 226 and the second appendage 228 may curve and be arranged radially outward from the first arm 236 and the second arm 238.

Besides the CVJ 232, the assembly 202 may include a first joint 245 and a second joint 247. The first joint 245 may be fit to the first appendage 226 and the first arm 236. The first joint 245 may couple the first appendage 226 to the first arm 236. The second joint 247 may be fit to the second appendage 228 and the second arm 238. The second joint 247 may couple the second appendage 228 to the second arm 238. The first joint 245 may provide relative motion between the first appendage 226 and the first arm 236. The second joint 247 may provide relative motion between the second appendage 228 and the second arm 238. Additionally or alternatively, the second joint 247 may be a king pin.

The axle shaft 222 may be supported and centered around the first axis 210 via a first bearing assembly 230. The first bearing assembly 230 may be radially around and contacting the axle shaft 222. The first bearing assembly 230 may include one or more ball bearings or other bearings. The first bearing assembly 230 may support and allow the axle shaft 222 to rotate independently from the axle housing 220. The first bearing assembly 230 may maintain an alignment of the axle shaft 222 with the first axis 210, such that the centerline of the axle shaft 222 is approximately co-axial with the first axis 210. The first bearing assembly 230 may be press fit against the inner surface of the tube 223 of the axle housing 220. Additionally or alternatively, the first bearing assembly 230 may be held in place via a bearing retainer. Additionally or alternatively, the first bearing assembly 230 may be slip fit with a snap ring 233. The snap ring 233 may be positioned radially around and contact the axle shaft 222. The ring 233 may abut the first bearing assembly 230, retaining the first bearing assembly 230 to the axle shaft 222.

The first bearing assembly 230 may be further retained via a bearing retainer 291. The bearing retainer 291 may be inserted into a tube of the axle housing 220. That is to say, the bearing retainer 291 may be in face-sharing contact with the inner surface of the tube 223 of the axle housing 220. The bearing retainer 291 may include a stop 292 that reduced an opening size of the tube of the axle housing 220. In one example, the stop 292 is configured to block further insertion of the first bearing assembly 230 into the tube. By doing this, the first bearing assembly 230 may be accurately arranged at a desired location of the tube 223 of the axle housing 220 to support the bar shaft 222 at a location proximal to the CVJ 232.

The bearing retainer 291 may further include an annular detent 294 arranged between the stop 292 and an outer lip 296. The outer lip 296 may be positioned outside the tube of the axle housing 220. The outer lip 296 may be configured to block further insertion of the bearing retainer 291 into the tube of the axle housing 220. The annular detent 294, in combination with the snap ring 233, may retain the first bearing assembly 230. Additionally or alternatively, the annular detent 294 may maintain a position of the first bearing assembly 230 within the tube of the axle housing 220. In one example, the bearing retainer 291 may include a z-shaped cross-section.

The bearing assembly 230, the snap ring 233, and the bearing retainer 291 may be positioned in a location of the tube 223 between the mounting bracket 225 and the CVJ 232. The axle shaft 222 may be cantilevered from an end of the first bearing assembly to an inner race of the CVJ 232.

The CVJ 232 may include an outer race 240, an inner race 244, and a cage 242. The outer race 240 may be shaped with portions that are cylindrical in shape and portions that are frustoconical in shape. For example, the outer race 240 may be a single piece including a first portion and a second portion that are cylindrical in shape, with a third portion that is frustoconical in shape. The third portion may be between the first portion and the second portion. The surfaces of the third portion may be continuous with the first portion and the second portion. The outer race 240 may surround and contact the cage 242. The cage 242 may be supported a plurality of bearings 241 of the CVJ 232. The bearings 241 may be ball bearings. In one example, the CVJ 232, including the outer race 240 and the cage 242 is a single piece.

The outer race 240 may be aligned with the second axis 211, such that the outer race 240 is centered radially around the second axis 211. Said in another way, the centerline of the outer race 240 may be co-axial with the second axis 211. Likewise, the inner race 244 is aligned with the second axis 211, such as to be centered about the second axis 211. Said in another way, the centerline of the inner race 244 may be co-axial with the second axis 211. The outer race 240 may rigidly couple to an output of the CVJ 232. The inner race 244 may couple to an input to the CVJ 232. For example, the outer race 240 may be seated within the wheel hub 205. In one example, the portion of the outer race 240 seated in the wheel hub 205 may only surround the spindle 216. The inner race 244 may mesh with a splined end 229 of the axle shaft 222 such that the spindle 216 may rotate with the inner race 244.

The bearings 241 and cage 242 may pivot relative to the outer race 240, and vice versa. The cage 242 may be pivoted such that the centerline so that in some conditions it is non-coaxial with the second axis 211 and the centerline of outer race 240.

The angle 212 is an angle less than or equal to first threshold angle, where the first threshold angle is a maximum angle. The angle 212 may be greater than the first threshold angle; however, at an angle greater than the first threshold, torque transferred across the CVJ 232 may be below a second threshold of power, increasing power losses and decreasing the efficiency at which torque is transferred.

The spindle 216 may be coupled to the inner race 244 and meshed with the splined end 282 of the stub shaft 218. As such, the stub shaft 218 may rotate via rotation of the spindle 216. The stub shaft 218 may be nested in and rotate the wheel hub 205.

As such, the axle shaft 222 may include a cantilevered portion that extends out of the tube 223 toward the inner race 244 of the CVJ 232. The cantilevered portion of the axle shaft 222 may be unsupported, wherein the splined end 229 thereof is in meshed engagement with the inner race 244 of the CVJ 232. In one example, there are no components, such as bearings, brackets, straps, or other forms of support contacting the cantilevered portion of the axle shaft 222. Additionally, the CVJ 232 may be the only CVJ corresponding to the wheel assembly 214. A separate CVJ may be associated with a different wheel assembly of the front axle such that the front axle includes a total of two CVJs and two wheel assemblies. The components illustrated in FIG. 2 may be replicated for the other wheel assembly of the front axle.

The wheel hub 205 may include a flange section 246 and a nose section 248. The flange section 246 may be in contact with the outer race 240 of the CVJ 232. The flange section 246 may extend radially from the nose section 248. The flange section 246 and the nose section 248 may be centered around the second axis 211. The wheel hub 205 may further include a frustoconical section 252 that is frustoconical in shape. The frustoconical section 252 may extend from the nose section 248. The frustoconical section 252 may connect to and extend in longitudinal direction from the flange section 246. The nose section 248 may receive the stub shaft 218 via a second opening 250. The second opening 250 may be a hole that is annular in shape, and may be concentric to the nose section 248. The flange section 246, the nose section 248, and the frustoconical section 252 may be a single piece defining an outer spindle. The stub shaft 218 may be arranged within second opening 250.

The nose section 248 may receive the stub shaft 218 via a second opening 250. The second opening 250 may be a hole that is annular in shape, and may be concentric to the nose section 248. The housing of the stub shaft 218 may include a plurality of volumes including a third opening 258 and a passage 259. The third opening 258 may be nearest to second side 206 and the CVJ 232. The passage 259 is longitudinally between the third opening 258 and the second opening 250. The second opening 250, the passage 259, and the third opening 258 may be continuous in volume. Surfaces that curve radially about and that define the second opening 250, the passage 259, and the third opening 258 may be continuous. The third opening 258 may have a frustoconical volume and couple to a portion of the outer race 240. In some examples, a volume of the third opening 258 may have a greater diameter than a diameter of a volume of the second opening 250. The third opening 258 may surround, receive, and house the outer race 240 or a portion of the outer race 240.

A second bearing assembly 256 may be radially around and in contact with the nose section 248 of the housing of the stub shaft 218. The second bearing assembly 256 may be radially around and in surface sharing contact with the nose section 248, thereby allowing the wheel hub 205 to rotate relative to the wheel assembly 214. The second bearing assembly 256 may be arranged such as to be sandwiched radially between and retained between the wheel assembly 214 and the wheel hub 205.

The wheel assembly 214 may include a first mounting flange 262 and a housing 264. For a first example configuration, the first mounting flange 262 may rigidly couple to the housing 264. The first mounting flange 262 may extend in an outward direction from a core of the housing 264, where outward is in a direction away from the second axis 211. The first mounting flange 262 may be a flange and may extend radially from the housing 264. The wheel assembly 214 may include a second mounting flange 266 rigidly coupled to the housing 264. As another example, the housing 264 may alternatively comprise the first mounting flange 262 and/or the second mounting flange 266.

The first mounting flange 262 may include a plurality of first through-holes 268 that may receive a plurality of first fasteners 270. As such, the plurality of first fasteners 270 may extend through the plurality of first through-holes 268. The plurality of first fasteners 270 may be studs or screws. The plurality of first fasteners 270 may fasten the first mounting flange 262 to at least one wheel.

The wheel assembly 214 may have a fourth opening 274. The fourth opening 274 may be concentric to and shaped by the first mounting flange 262, where the fourth opening 274 may be centered on the second axis 211. The fourth opening 274 may receive the stub shaft 218. The fourth opening 274 may include an interior volume 272 that is sealed via a bearing seal 276 and an end cap 280. The bearing seal 276 may be positioned on the stub shaft 218 and configured to allow the stub shaft 218 to rotate relative to other elements of the assembly 202. A portion of the stub shaft 218 may extend from the bearing seal 276, across the fourth opening 274, and to the end cap 280. In one example, the end cap 280 is a single piece, integrally arranged with the stub shaft 218.

The end cap 280 may be physically coupled to a third mounting flange 290. A plurality of fasteners 284 may extend through through-holes 288 of the end cap 280 and physically couple to a third mounting flange 290. In one example, each of the first mounting flange 262, the second mounting flange 266, and the third mounting flange 290 may be arranged on the same piece, such as the housing 264. In this way, the housing 264, may be a single, stationary piece with three mounting flanges that houses a portion of the stub shaft 218 extending from the second bearing assembly 256 to the end cap 280.

In this way, by mounting the bearing on the bar shaft connected to the CVJ inside the axle housing tube, direct support may be provided to the CVJ while also reducing a demand to support the outer race of the CVJ. This may simplify manufacturing and reduce tolerance-stacking between the CVJ and a kingpin axis, which may maintain alignment more efficiently. The bearing arrangement may also improve serviceability. The CVJ may stay in place when the spindle is removed for service. By cantilevering the CVJ, manufacturing and service costs are reduced while better maintaining alignment between the CVJ and the kingpin axis, thereby improving customer satisfaction and vehicle performance.

The disclosure also provides support for a system, comprising: a first shaft extending through an axle housing, a constant velocity joint (CVJ) coupled to the first shaft at a location outside of the axle housing, a bearing assembly arranged at an end of the axle housing proximal to the CVJ, and a second shaft extending through a wheel hub assembly and coupled to the CVJ, wherein an outer race of the CVJ is in face-sharing contact with a wheel hub of the wheel hub assembly. In a first example of the system, the first shaft is cantilevered downstream of the bearing assembly to the CVJ. In a second example of the system, optionally including the first example, the first shaft is a bar shaft and the second shaft is a stub shaft. In a third example of the system, optionally including one or both of the first and second examples, the bearing assembly is retained via a bearing retainer inserted into a tube of the axle housing. In a fourth example of the system, optionally including one or more or each of the first through third examples, the bearing retainer comprises a stop, an annular detent, and an outer lip, wherein the outer lip is positioned outside of the tube. In a fifth example of the system, optionally including one or more or each of the first through fourth examples, the bearing assembly is retained via a snap ring. In a sixth example of the system, optionally including one or more or each of the first through fifth examples, a mount is coupled to the axle housing. In a seventh example of the system, optionally including one or more or each of the first through sixth examples, the bearing assembly is arranged at a position between the mount and the CVJ.

The disclosure also provides support for a drivetrain assembly, comprising: an axle assembly including a bar shaft supported by a bearing assembly near an extreme end of the axle assembly, a constant velocity joint (CVJ) coupled to a cantilevered portion of the bar shaft, and a stub shaft coupled to the CVJ. In a first example of the system, the CVJ is supported via only the cantilevered portion of the bar shaft and a wheel hub. In a second example of the system, optionally including the first example, an outer race of the CVJ is in face-sharing contact with the wheel hub. In a third example of the system, optionally including one or both of the first and second examples, the CVJ comprises a spindle in meshed engagement with a splined end of the stub shaft. In a fourth example of the system, optionally including one or more or each of the first through third examples, the stub shaft comprised an endplate coupled to a wheel assembly. In a fifth example of the system, optionally including one or more or each of the first through fourth examples, the bar shaft is arranged in a tube of the axle assembly, and wherein the cantilevered portion of the bar shaft extends out of the tube from the bearing assembly to the CVJ. In a sixth example of the system, optionally including one or more or each of the first through fifth examples, the cantilevered portion of the bar shaft comprises a splined end in meshed engagement with an inner race of the CVJ.

The disclosure also provides support for a system for a vehicle, comprising: a constant velocity joint (CVJ) supported by a cantilevered portion of a bar shaft extending out of a tube of an axle assembly, the CVJ is further supported via a wheel hub in face-sharing contact with an outer race of the CVJ, and a bearing assembly arranged in the tube of the axle assembly a location in which the bar shaft exits the tube. In a first example of the system, the bearing assembly is retained within the tube via a snap ring and a bearing retainer. In a second example of the system, optionally including the first example, the bearing retainer comprises a z-shaped cross-section. In a third example of the system, optionally including one or both of the first and second examples, a mount is coupled to the axle assembly, the mount comprising a bracket with two through-holes. In a fourth example of the system, optionally including one or more or each of the first through third examples, the wheel hub is coupled to a steering knuckle.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of prime movers, internal combustion engines, and/or transmissions. The subject matter of the present disclosure includes all novel and non-obvious combinations and sub-combinations of the various systems and configurations, and other features, functions, and/or properties disclosed herein.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a first shaft extending through an axle housing;
a constant velocity joint (CVJ) coupled to the first shaft at a location outside of the axle housing;
a bearing assembly arranged at an end of the axle housing proximal to the CVJ; and
a second shaft extending through a wheel hub assembly and coupled to the CVJ; wherein
an outer race of the CVJ is in face-sharing contact with a wheel hub of the wheel hub assembly.

2. The system of claim 1, wherein the first shaft is cantilevered downstream of the bearing assembly to the CVJ.

3. The system of claim 1, wherein the first shaft is a bar shaft and the second shaft is a stub shaft.

4. The system of claim 1, wherein the bearing assembly is retained via a bearing retainer inserted into a tube of the axle housing.

5. The system of claim 4, wherein the bearing retainer comprises a stop, an annular detent, and an outer lip, wherein the outer lip is positioned outside of the tube.

6. The system of claim 1, wherein the bearing assembly is retained via a snap ring.

7. The system of claim 1, wherein a mount is coupled to the axle housing.

8. The system of claim 7, wherein the bearing assembly is arranged at a position between the mount and the CVJ.

9. A drivetrain assembly, comprising:
an axle assembly including a bar shaft supported by a bearing assembly near an extreme end of the axle assembly;
a constant velocity joint (CVJ) coupled to a cantilevered portion of the bar shaft; and
a stub shaft coupled to the CVJ.

10. The drivetrain assembly of claim 9, wherein the CVJ is supported via only the cantilevered portion of the bar shaft and a wheel hub.

11. The drivetrain assembly of claim 10, wherein an outer race of the CVJ is in face-sharing contact with the wheel hub.

12. The drivetrain assembly of claim 9, wherein the CVJ comprises a spindle in meshed engagement with a splined end of the stub shaft.

13. The drivetrain assembly of claim 9, wherein the stub shaft comprised an end plate coupled to a wheel assembly.

14. The drivetrain assembly of claim 9, wherein the bar shaft is arranged in a tube of the axle assembly, and wherein the cantilevered portion of the bar shaft extends out of the tube from the bearing assembly to the CVJ.

15. The drivetrain assembly of claim 9, wherein the cantilevered portion of the bar shaft comprises a splined end in meshed engagement with an inner race of the CVJ.

16. A system for a vehicle, comprising:
a constant velocity joint (CVJ) supported by a cantilevered portion of a bar shaft extending out of a tube of an axle assembly, the CVJ is further supported via a wheel hub in face-sharing contact with an outer race of the CVJ; and
a bearing assembly arranged in the tube of the axle assembly a location in which the bar shaft exits the tube.

17. The system of claim 16, wherein the bearing assembly is retained within the tube via a snap ring and a bearing retainer.

18. The system of claim 17, wherein the bearing retainer comprises a z-shaped cross-section.

19. The system of claim 16, wherein a mount is coupled to the axle assembly, the mount comprising a bracket with two through-holes.

20. The system of claim 16, wherein the wheel hub is coupled to a steering knuckle.
